(19) United States
(12) Patent Application Publication
(10) Pub. No.: US 2009/0226265 A1
(43) Pub. Date: Sep. 10, 2009

(54) Points Switch Provided with Modular Fixed Coffers

(76) Inventors: Remy Lopez, Octeville sur Mer (FR); Haim Touitou, Octeville Sur Mer (FR)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 12/226,458

(22) PCT Filed: Apr. 4, 2007
(86) PCT No.: PCT/FR2007/051070

§ 371 Date: Mar. 9, 2009

(30) Foreign Application Priority Data
Apr. 18, 2006 (FR) 0603428

(51) Int. Cl. B65G 51/03

(52) U.S. Cl. 406/183

(57) ABSTRACT

The object of the present invention is a points switch for an overhead air conveyor or carrier, which is essentially constituted by fixed input and/or output coffers (1 and 2) connected to a mobile switching device (3), the assembly being mounted on a support infrastructure (4) and the upstream and/or downstream transport coffers (1 and 2) being connected to overhead air conveyors or carriers. Points switch characterised in that the fixed input and/or output coffers (1 and 2) are interchangeable modular fixed coffers connected to each other and with the mobile device for points switching the products or bottles (5) and the lines of overhead air conveyors or carriers, in a removable way. The invention has more particular application in the field of load conveying using overhead air conveyors or carriers.

This invention concerns the field of load conveying using overhead air conveyors or carriers, in particular point switches for such air conveyors or carriers and primarily fixed coffers on such point switches, and its object is such a point switch with modular fixed coffers.

Overhead air conveyors or carriers are intended for moving relatively lightweight products, guided in a rail on such conveyors or carriers, by the action of a pressurized air flow over said products as they are guided in the rail.

To this end, these overhead air conveyors or carriers consist of coffers with a guide rail for the products to be carried attached to the bottom of each coffer. The rail has nozzles that eject pressurized air in the product movement direction, as well as a means under the rail for holding the tops of the products to the rail, where the coffer is supplied with pressurized air through corresponding air lines and also has sensors or other means of control connected to a central control unit by electrical wiring. All of these coffers are mounted under a framework structure.

To allow for changing the direction of products, regrouping products, or distributing products in different directions, the coffers are connected to one or more point switches integrated between the coffers. These point switches generally include a cartridge that moves transversally on the lengthwise axis of the coffers, where this mobile cartridge is itself inserted into a fixed assembly equipped with transversal guides for the cartridge and tubular pieces attaching the coffers successively to a mobile cartridge deviation channel.

Such a mobile cartridge has several inputs or outputs for deviation coffers on its connecting sides, which are connected to each other and intended to meet with the corresponding end of one or the other of the junction coffers of the tubular coffers upstream and downstream from the mobile cartridge, in order to permit another orientation of the carried products. The mobile cartridge is moved transversally by a jack type of actuator, which makes successive connections as needed between the deviation coffers and the junction coffers for the carrying coffers.

French patent No. 05 54112 describes an air conveyor or carrier that consists essentially of carrier coffers upstream and downstream, connected to each other by a point switch. This point switch consists of a carrying and guiding assembly that is flexible with respect to its lengthwise axis and attached at one end to the support infrastructure or to an upstream or downstream carrying coffer, whose guiding part corresponds to that of an upstream or downstream coffer, and the other end of this flexible carrying and guiding assembly is guided on the infrastructure with the possibility of angular motion and connected to a means of side-to-side motion. This type of point switch, more lightweight and of simpler design, permits a significant reduction in inertia, allowing for higher speeds than preceding point switches.

EP-A-0 310 102 and FR-A-2 824 544 also describe interchangeable coffers, but which require adaptation of the fixed upstream and downstream coffers located between the point switch and the air conveyor lines. To allow for this adaptation, the coffers according to these two documents are executed based on the specific orientation needs of the products conveyed. These coffers are therefore not adapted for modification of the conveyor and must be replaced with new coffers adapted to new needs. This requires maintaining an inventory of adaptation parts and a corresponding significant increase in modification costs.

Generally, the point switches known to date satisfactorily perform the function of changing direction between the upstream and downstream coffers that connect to the overhead air conveyors or carriers.

However, due to the need to adapt the fixed upstream and downstream coffers located between the point switch and the overhead air conveyor or carrier lines, the resulting modification costs and related investments are fairly high and contribute to their significantly higher overall cost.

The purpose of this invention is to eliminate these inconveniences by proposing a point switch equipped with fixed coffers that can be interchanged easily without requiring significant investments.

To this end, the point switch, which consists essentially of fixed input and/or output coffers connected to overhead air conveyor or carrier lines and of at least one device for mobile point switching of products between the fixed input and/or output coffers, is distinguished in that the fixed input and/or output coffers are modular interchangeable coffers connected to each other, to the mobile point switch for products, and to the overhead air conveyors or carriers, in such a way that they can be removed.

The invention will be better understood from the following description, which refers to a preferred mode of execution, given as a non-limiting example and explained with reference to the attached schematic drawings, in which:

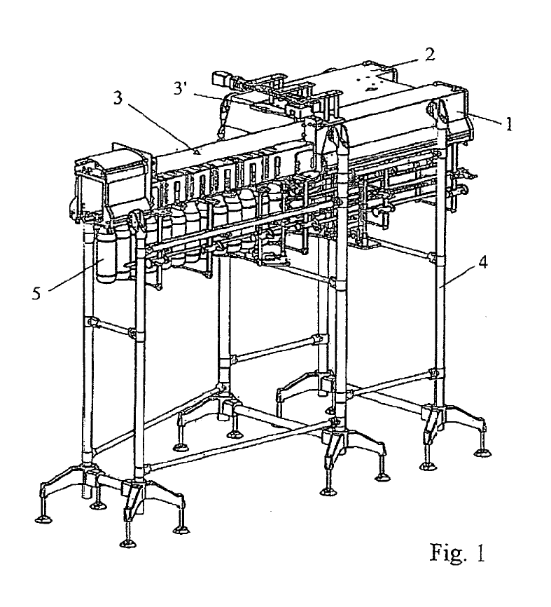

FIG. 1 is a partial perspective view of an air conveyor or carrier point switch equipped with coffers according to the invention;

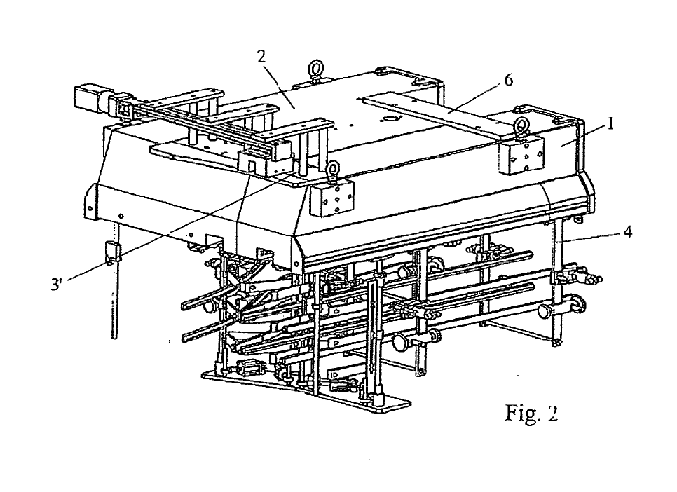

FIG. 2 is a perspective view of a coffer assembly according to the invention;

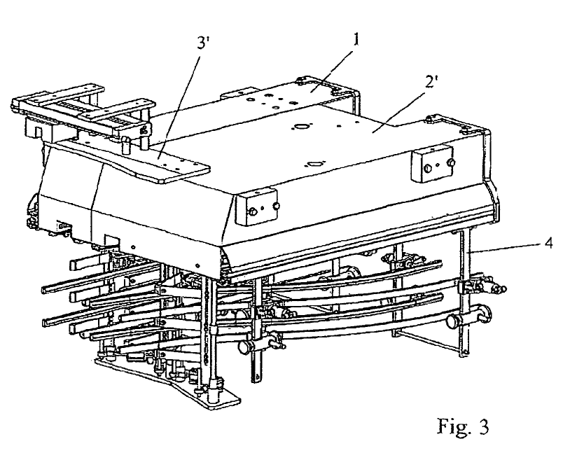

FIG. 3 is a view similar to FIG. 2, showing another possible coffer assembly according to the invention, and

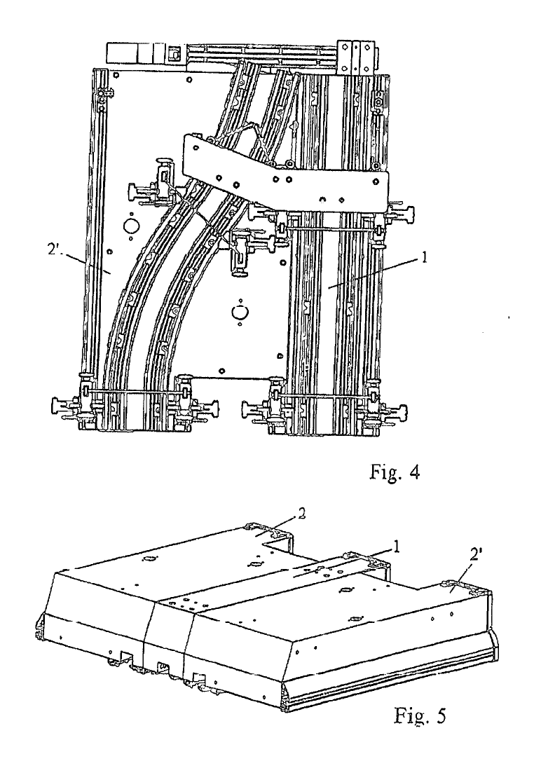

FIG. 4 is a plane and cross-section view of the deviation coffer from the assembly shown in FIG. 3;

FIG. 5 is a perspective view of another variation of the coffer assembly according to the invention.

FIG. 1 of the attached drawings shows, as an example, an air conveyor or carrier that consists essentially of fixed input and/or output coffers 1 and 2 connected to a mobile point switch 3, with the assembly mounted on a support infrastructure 4. In standard form, the upstream and/or downstream transport coffers 1 and 2 are connected to overhead air conveyor or carrier lines, not shown. In the mode of execution shown in FIG. 1, the point switch is type 2/1 or 1/2, depending on the products carried or conveyed, shown here with bottles 5, circulating from right to left or from left to right, with the orientation and/or distribution controlled by the mobile point switch 3.

According to the invention, the fixed input and/or output coffers 1 and 2 are interchangeable modular fixed coffers connected to each other, to the mobile point switch for products or bottles 5, and to the overhead air conveyors or carriers, in such a way that they can be removed.

To this end, and as shown specifically in FIGS. 2 to 5 of the attached drawings, the interchangeable modular fixed coffers are essentially either the straight type of coffer 1, with no deviation, or the type of coffer shown as 2 or 2′ (FIGS. 2 and 3 respectively), with deviation either upward with respect to the straight coffer 1 (FIG. 2) or downward with respect to the straight coffer 1 (FIGS. 3 and 4). FIG. 4 of the attached drawings shows the juxtaposed assembly of a straight interchangeable modular fixed coffer 1 and an interchangeable modular fixed coffer 2′, with deviation in one direction from the straight coffer 1.

With such a configuration of the interchangeable modular fixed coffers 1, 2, and 2′, it is easier to install the point switch input and/or output coffers, since these interchangeable modular fixed coffers 1, 2, and 2′ are totally independent of each other and can be assembled to each other by simply bolting their adjacent walls together, attaching them to crossbars 6 on the support infrastructure 4, and fastening their side that is towards the mobile point switch for products or bottles 5 to a guide 3′ on that mobile point switch for products or bottles 5.

These fixed point switch coffers 1, 2, and 2′ are commonly equipped with standard ways to move the products or bottles 5 to be carried or conveyed, such as air jet devices connected to distribution channels integrated into the coffers, which can be connected to the line upstream or downstream. These devices are known in the profession and are not described in any further detail.

FIG. 5 of the attached drawings shows one way to execute the invention, in which the three types of modular fixed coffers 1, 2, and 2′ are shown in an assembly that allows either regrouping of products or bottles coming from three different lines into a single line or, inversely, distribution of products or bottles from a single line in three different directions.

The assembly according to FIG. 5 shows that, with a modular fixed coffer assembly according to FIG. 2 or FIG. 3, it is possible to install all of the modular fixed coffers according to FIG. 5 by simply juxtaposing a modular fixed coffer 2′ or 2 respectively with the assembly as in FIG. 2 or FIG. 3. Thus, when it is necessary to change a conveyor or carrier installation, for example from a 1/2 or 2/1 point switch to a 1/3 or 3/1 point switch, all that is needed is to add an additional modular fixed coffer 2′ or 2 to the modular fixed input and/or output coffers 1 and 2 or 2′ for that point switch, without having to disassemble the existing point switch and in particular the fixed part of that point switch.

In addition, the separation of lines from a pneumatic standpoint, made possible by modularity, makes it possible to vary the speed of each line independently from any other. This means that the products or bottles can be moved at full speed on one line, while on a neighboring line the products or bottles are conveyed or carried at a low speed, which prevents said products or bottles from hitting hard against a retaining device in train formation.

The invention makes it possible to install point switches for overhead air conveyors or carriers that allow very rapid modifications of conveyor or carrier lines, by adding or removing a line or by changing a deviation direction, without the need for complete replacement of the fixed input and output coffers and the related labor and material costs.

In addition, due to the modular execution using a small number of interchangeable modular fixed coffers, generally three coffers, the mode of execution according to the invention allows considerable reduction of the costs for installing overhead conveyor or carrier lines for products, particularly bottles.

Of course, the invention is not limited to the mode of execution described here and shown in the attached drawings. Modifications are possible, regarding the composition of various elements or by substituting equivalent techniques, without going outside of the invention's scope of protection.

1. Point switch for an overhead air conveyor or carrier, consisting essentially of fixed input and/or output coffers (1 and 2 and/or 2′) connected to a mobile point switch (3), and that assembly mounted on a support infrastructure (4), where the upstream and/or downstream transportation coffers (1 and 2 and/or 2′) are connected to overhead air conveyor or carrier lines, distinguished in that the fixed input and/or output coffers (1 and 2 and/or 2′) are interchangeable modular fixed coffers connected to each other, to the mobile point switch for products or bottles (5), and to the overhead air conveyor or carrier lines, in such a way that they are removable.

2. Point switch as in claim 1, distinguished in that the interchangeable modular fixed coffers (1, 2, 2′) are essentially either the straight type of coffer 1, with no deviation, or the type of coffer shown as 2 or 2′, with deviation either in one direction with respect to the straight coffer (1) or in the other direction with respect to the straight coffer (1).

3. Point switch as in claim 1, distinguished in that the interchangeable modular fixed coffers (1, 2, and 2′) are totally independent of each other and can be assembled to each other by bolting their adjacent walls together and attaching them to the crossbars (6) on the support infrastructure 4, and fastening their side that is towards the mobile point switch for products or bottles (5) to a guide (3′) on that mobile point switch for products or bottles (5).
